(19) United States
(12) Patent Application Publication
(10) Pub. No.: US 2011/0045793 A1
(43) Pub. Date: Feb. 24, 2011

(54) Method circuit and system for receiving and processing multi-frames

(76) Inventor: Itzik Klein, Kfar-Monash (IL)

Correspondence Address: EITAN MEHULAL LAW GROUP, 10 Abba Eban Blvd. PO Box 2081, Herzlia, 46120, IL

(21) Appl. No.: 12/461,753

(22) Filed: Aug. 24, 2009

(51) Int. Cl. H04B 1/16

(52) U.S. Cl. 455/337

(57) ABSTRACT

Disclosed is a receiver containing a receive chain, a shared buffer, a decoder circuit, and an output interface. The receive chain may be adapted to receive and demodulate a data frame bearing signal received at one or more carrier frequencies. The receive chain may be further adapted to store demodulated data in a shared buffer. The decoder circuit may be adapted to read received data from the shared buffer, process the received data and write the decoded data back to the shared buffer. The output interface may be adapted to read the processed data and to provide read data to one or more external data sink circuits or applications.

### FIELD OF THE INVENTION

The present invention relates generally to the field of communication. More specifically, the present invention relates to a method, circuit and system for receiving and processing multi-frames.

### BACKGROUND

Modern communication networks are characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiFi, etc.) are used to supplement coverage for various devices (e.g. cell phone, wireless IP phone, wireless interne appliance, etc.) not physically connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomena, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power. The combination of attenuation, noise interference and “fading” is a substantial limitation for wireless network operators, mitigating their ability to provide high data-rate services such as Internet access and video phone services.

Some modern RF receivers may use various techniques and circuits implementing these techniques to compensate for phenomenon resulting from weak signal and interference. For example, improving the memory and buffering systems allows data to be processed at a faster rate after receiving signals. However, having more robust processing increases energy consumption as more elaborate circuits and systems are required.

There exists a need in the field of wireless communications for improved methods, circuits, devices and systems for receiving and processing multi-frames.

### SUMMARY OF THE INVENTION

The present invention is a method, circuit and system for receiving and processing multi-frames. According to some embodiments of the present invention, there is provided a circuit and system for wireless data communication along a given radio frequency (RF) carrier frequency (i.e. channel) or a plurality of channels from the set of available channels. The circuit may include an RF transmitter for wireless data broadcasting. According to further embodiments of the present invention, there is provided an RF receiver that may receive wireless data signals through an antenna and prepare them for one or more external data sink circuits or applications by filtering, amplifying and demodulating the signals.

According to some embodiments of the present invention, the receiver may perform RF amplification (i.e. amplifying the incoming signal), mixing (i.e. down converting the channel center frequency to baseband), baseband amplification (i.e. amplifying the baseband signal for analog-to-digital converting), deinterleaving the digital data bytes, decoding (i.e. converting the data into output signals with error correction) and any associated functions.

According to some embodiments of the present invention, the operations performed by the receiver before the decoding (i.e. the receive chain) may handle each time slot (e.g. a portion of a multiplexed data frame) sequentially. According to some embodiments of the present invention, the decoder circuit may handle several time slots (e.g. a complete multiplexed data frame) with the same operation. According to further embodiments of the present invention, the decoder circuit may concurrently handle multiple data frames by collecting data of the following frame and clearing the data of the previous frame while serving a given frame. According to some embodiments of the present invention, collecting data of the following frame may involve filling the byte deinterleaver with the most recent data. According to some embodiments of the present invention, clearing the data of the previous frame may include a data transfer to the output interface. According to some embodiments of the present invention, serving a given frame may entail Reed-Solomon error correction, parsing the frame header information and demultiplexing the frame content.

According to some embodiments of the present invention, the decoder circuit may employ a memory protection scheme while allowing concurrent access to the data buffer from multiple processes. According to further embodiments of the present invention, the same data buffer may be used for filling the byte deinterleaver, obtaining decoded data after Reed-Solomon error correction, and making the data available to the output interface. According to some embodiments of the present invention, there may be a hardware implementation for concurrent access to a data buffer for a plurality of circuits and/or applications. According to further embodiments of the present invention, the data buffer may be segmented into exclusively accessible regions for simultaneous access to the buffer. According to some embodiments of the present invention, demodulated data may be stored in dynamic chunks of memory within the shared data buffer. According to further embodiments of the present invention, a plurality of dynamic chunks of memory may contain the data of a complete data frame. According to further embodiments of the present invention, data of complete data frames may be stored in static memory locations with maximal buffer size.

According to some embodiments of the present invention, the power to the receive chain and the decoder circuit may be independently controlled. According to further embodiments of the present invention, power consumption may be reduced by enabling power cycling for each circuit. According to further embodiments of the present invention, the receive chain may receive a burst of data while the decoder circuit is in a powered down state. According to further embodiments of the present invention, the decoder circuit may function in between bursts of data reception while the receive chain is in a powered down state.

According to some embodiments of the present invention, it may be advantageous for the byte deinterleaver to delay handling collected data before sending the data to the decoder. According to some embodiments of the present invention, the demodulation and decoding sub-circuit may fill the byte deinterleaver to capacity before handling the data and transferring the data to the decoder. According to further embodiments of the present invention when data is received in bursts, the byte deinterleaver may collect a complete burst of data (e.g. a plurality of multiplexed data frames) before handling the data and transferring the data to the decoder.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a functional block diagram of an exemplary data receiver according to some embodiments of the present invention where the receiver includes a receive chain, shared buffer and decoder circuit.

FIG. 2A is a flowchart including the steps of a method of receiving, demodulating, decoding and power cycling in a case of non-consecutive frames and in accordance with the exemplary embodiment of FIG. 1.

FIG. 2B is a flowchart including the steps of a method of receiving, demodulating, decoding and power cycling in a case of consecutive frames and in accordance with the exemplary embodiment of FIG. 1.

FIG. 3 is a functional block diagram of an exemplary shared data buffer according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, DVDs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

It should be understood that some embodiments of the present invention may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

According to some embodiments of the present invention there is provided a receiver containing a receive chain, a shared buffer, a decoder circuit, and an output interface.

According to some embodiments of the present invention, the receive chain may be adapted to receive and demodulate a data frame bearing signal received at one or more carrier frequencies. According to further embodiments of the present invention, the receive chain may be further adapted to store demodulated data in a shared buffer. According to some embodiments of the present invention, the decoder circuit may be adapted to read received data from the shared buffer, process the received data and write the decoded data back to the shared buffer. According to some embodiments of the present invention, the output interface may be adapted to read the processed data and to provide read data to one or more external data sink circuits or applications.

According to some embodiments of the present invention, the receive chain may be adapted to receive and demodulate each time slot of the data frame bearing signal sequentially (i.e. constant flow of reception when the signal is being transmitted). According to further embodiments of the present invention, the decoder circuit may reconstruct complete data frames from the demodulated data. According to further embodiments of the present invention, it may be advantageous for the decoder circuit to handle a plurality of complete data frames with a single operation. According to further embodiments of the present invention, handling of multiple frames may be enabled in the decoder by serving a given data frame while simultaneously collecting data of the following frame and clearing the data of the previous frame.

According to some embodiments of the present invention, the receiver may employ an energy conservation mechanism in which the receive chain is power cycled when the data frame bearing signal is received in bursts. According to further embodiments of the present invention, the receive chain may be powered down in between bursts of signal reception (i.e. when there is an insignificant probability of losing data). According to some embodiments of the present invention, the receiver may employ an energy conservation mechanism in which the decoder circuit is power cycled when the data frame bearing signal is received in bursts. According to further embodiments of the present invention, the decoder circuit may be powered down during bursts of signal reception since there is a natural delay in between collecting of data and packaging the demodulated data for the decoder circuit wherein the decoder is inactive.

According to some embodiments of the present invention, the decoder circuit may contain a byte deinterleaver and an error correcting decoder (e.g. Reed-Solomon decoder). According to further embodiments of the present invention, it may be advantageous to read a complete data frame from the shared buffer for deinterleaving the data and transferring the data to the error correcting decoder. According to further embodiments of the present invention, it may be advantageous to read a complete burst of the data frame bearing signal from the shared buffer for deinterleaving the data and transferring the data to the error correcting decoder.

According to some embodiments of the present invention, the shared buffer may contain a plurality of independently accessible segments (i.e. several physical memory modules within the shared buffer). According to further embodiments of the present invention, each segment of the shared buffer may be accessible to one circuit or application at each clock interval.

According to some embodiments of the present invention, the shared buffer may be designed with memory that is allocated as dynamic chunks in addition to static memory locations. According to further embodiments of the present invention, dynamic memory chunks may be used for storing fragments of demodulated data output from the receive chain. According to further embodiments of the present invention, the shared buffer may have the functionality to move a selected plurality of dynamic chunks to a static memory location. According to further embodiments of the present invention, it may be advantageous for the shared buffer to collect demodulated data as dynamic memory chunks, package the data into complete data frames and move the data frames into a static memory location.

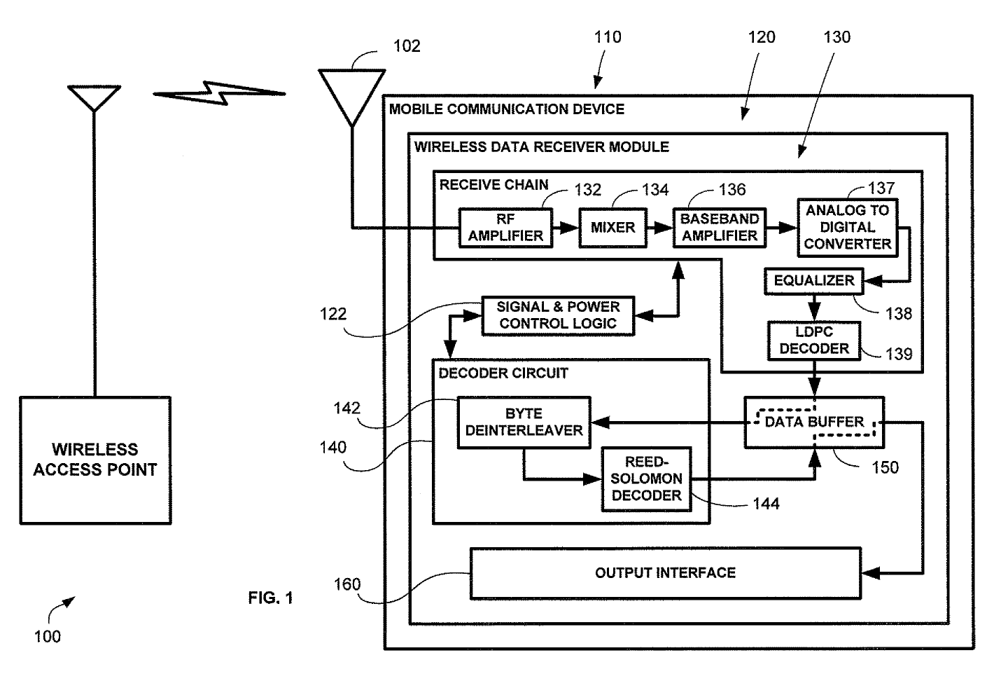

Turning now to FIG. 1, there is shown an exemplary data receiver according to some embodiments of the present invention where the receiver includes a receive chain, shared buffer and decoder circuit.

According to some embodiments of the present invention, there may be a circuit and system (100) for wireless communication between a base station and a mobile communication device (110) along a given carrier frequency (i.e. channel). According to further embodiments of the present invention, the mobile communication device (110) may include a wireless data receiver (120) that receives wireless signal through a functionally associated antenna (102). According to further embodiments of the present invention, the wireless data receiver may include a receive chain (130) to perform RF amplification (i.e. amplifying the incoming signal), mixing (i.e. down converting the channel center frequency to baseband), and baseband amplification (i.e. amplifying the baseband signal for analog-to-digital converting) as well as an analog to digital converter (137). According to further embodiments of the present invention, the receive chain may include an equalizer (138) and a low-density parity-check (LDPC) decoder (139) to perform the first stage of decoding (i.e. the real-time decoding stage).

According to some embodiments of the present invention, the wireless data receiver may contain a shared data buffer (150) for temporary storage of data as well as read access for associated circuits and/or applications. According to further embodiments of the present invention, the wireless data receiver may include a decoder circuit (140) comprising a byte deinterleaver (142) and Reed-Solomon decoder (144) for processing digital data frames.

According to some embodiments of the present invention, the wireless data receiver may include signal & power control logic (122) for determining and adjusting optimal gain values for the amplifiers, and power cycling the various sub-circuits. According to some embodiments of the present invention, the wireless data receiver may include an output interface (160) to read the processed data and to provide read data to one or more external data sink circuits or applications.

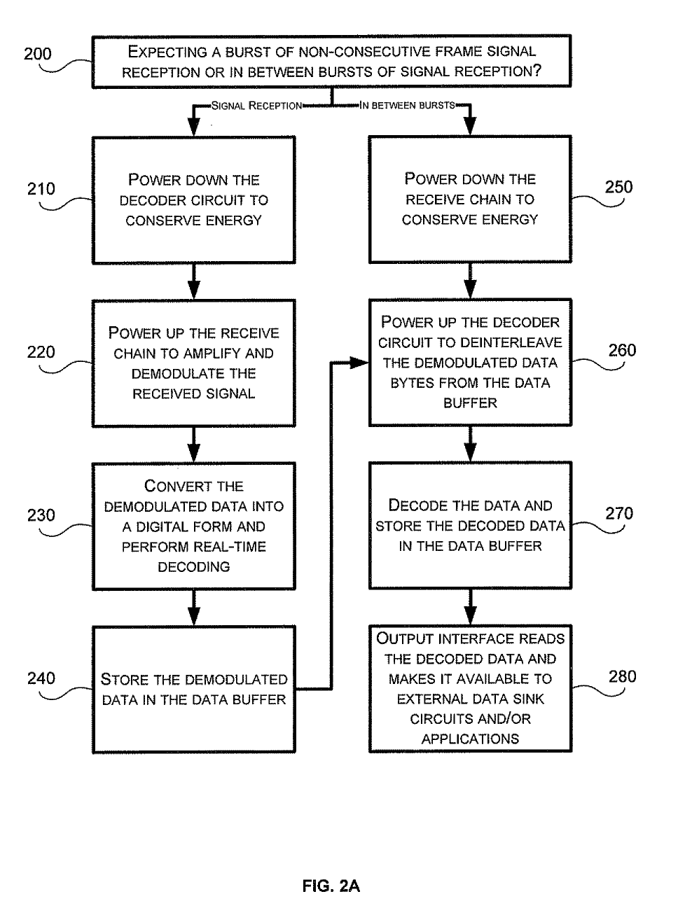

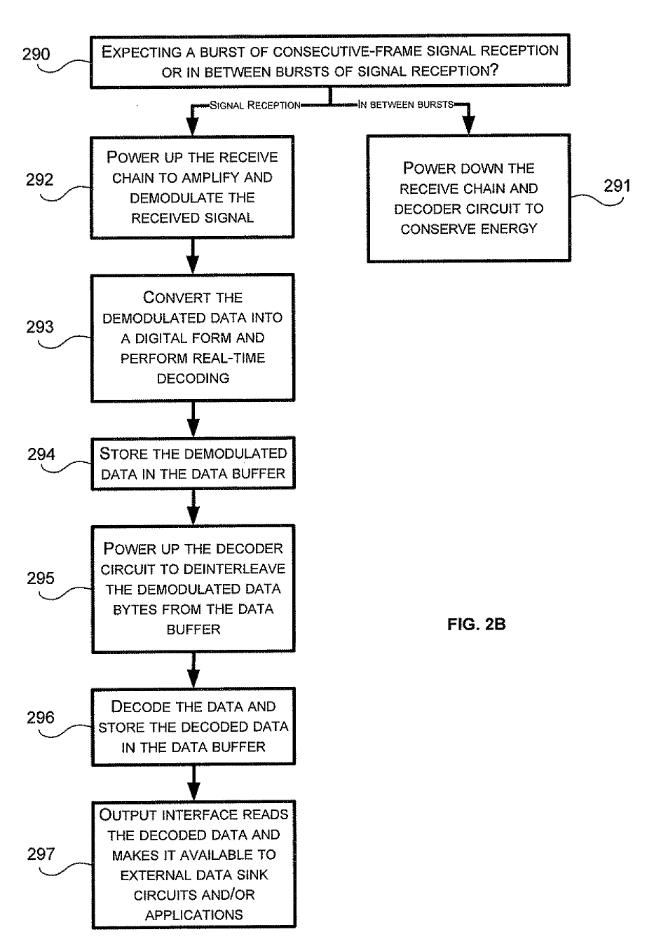

The operation of the receiver may be described in view of FIG. 2A showing a flow chart including the steps of an exemplary method of receiving, demodulating, decoding and power cycling in a case of non-consecutive frames.

According to some embodiments of the present invention, there may be periods of time when a frame data bearing signal is received in bursts. According to further embodiments of the present invention, the control logic (122) may power down (210) the decoder circuit (140) during periods of signal reception bursts to conserve energy in view of the fact that the decoder circuit lacks sufficient data to process at this stage. According to further embodiments of the present invention, the control logic (122) may power up (220) the receive chain (130) to amplify and demodulate the received signal for analog to digital conversion (230) performed by the analog to digital converter (137) and to perform real-time decoding (230) with the equalizer (138) and LDPC decoder (139). According to further embodiments of the present invention, the digital demodulated data may be stored (240) in the shared data buffer (150) for further processing by a functionally associated circuit and/or application.

According to some embodiments of the present invention, there may be time periods in between bursts of frame data bearing signal reception. According to further embodiments of the present invention, the control logic (122) may power down (250) the receive chain (130) in between signal reception bursts to conserve energy in view of the fact that the receive chain is only active when a signal is being received. According to further embodiments of the present invention, the control logic (122) may power up (260) the decoder circuit (140) to read the digital demodulated data from the shared data buffer (150) and deinterleave the bytes of data with a byte deinterleaver (142). According to further embodiments of the present invention, the deinterleaved data may be decoded (270) by a Reed-Solomon decoder (144) and may then be stored in the shared data buffer (150). According to further embodiments of the present invention, the output interface (160) may read (280) the decoded data and may make it available to external data sink circuits and/or applications.

The operation of the receiver may be described in view of FIG. 2B showing a flow chart including the steps of an exemplary method of receiving, demodulating, decoding and power cycling in a case of consecutive frames.

According to some embodiments of the present invention, there may be periods of time when a frame data bearing signal is received in bursts. According to further embodiments of the present invention, the control logic (122) may power up (292) the receive chain (130) to amplify and demodulate the received signal for analog to digital conversion (293) performed by the analog to digital converter (137) and to perform real-time decoding (293) with the equalizer (138) and LDPC decoder (139). According to further embodiments of the present invention, the digital demodulated data may be stored (294) in the shared data buffer (150) for further processing by a functionally associated circuit and/or application. According to further embodiments of the present invention, the control logic (122) may power up (295) the decoder circuit (140) to read the digital demodulated data from the shared data buffer (150) and deinterleave the bytes of data with a byte deinterleaver (142). According to further embodiments of the present invention, the deinterleaved data may be decoded (296) by a Reed-Solomon decoder (144) and may then be stored in the shared data buffer (150). According to further embodiments of the present invention, the output interface (160) may read (297) the decoded data and may make it available to external data sink circuits and/or applications.

According to some embodiments of the present invention, there may be time periods in between bursts of frame data bearing signal reception. According to further embodiments of the present invention, the control logic (122) may power down (291) the receive chain (130) and decoder circuit (140) in between signal reception bursts to conserve energy in view of the fact that the receive chain and decoder circuits are only active when a signal is being received.

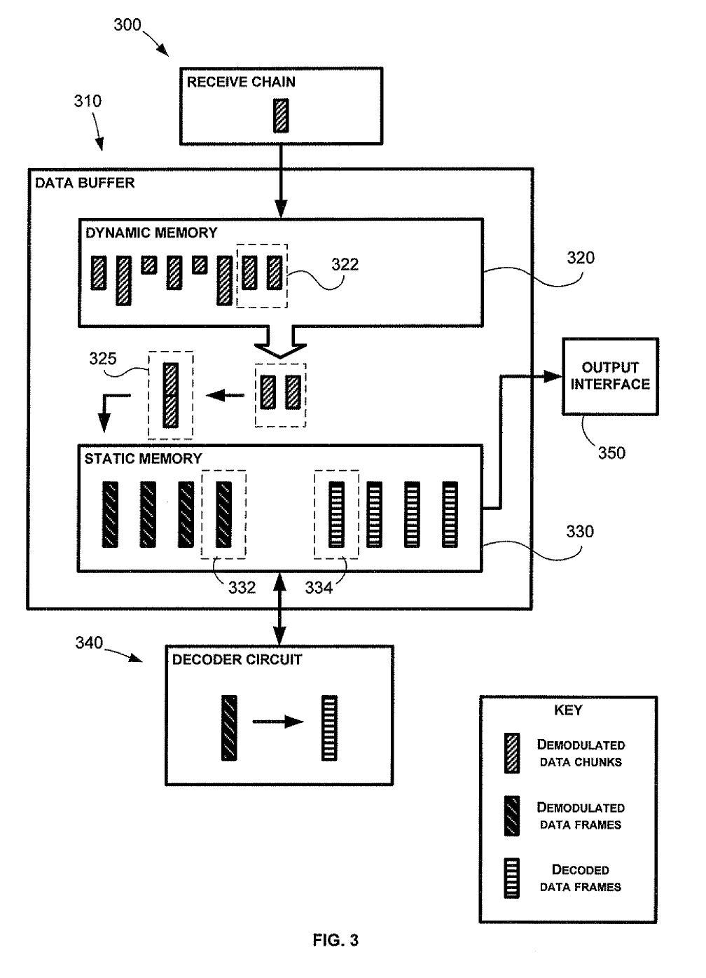

Now turning to FIG. 3, there is shown a functional block diagram of an exemplary shared data buffer according to some embodiments of the present invention.

According to some embodiments of the present invention, a receive chain (300) may receive and demodulate each time slot of a frame data bearing signal sequentially which, after analog to digital conversion, may be handled as individual data chunks. According to further embodiments of the present invention, data chunks may have a length equal to an integer division of the length of a complete data frame.

According to some embodiments of the present invention, there may be a shared data buffer (310) that contains at least one segment of dynamic memory and at least one segment of static memory. According to further embodiments of the present invention, data chunks from the receive chain may be stored in a dynamic memory buffer (320) that is adapted to store data chunks which have variable length. According to further embodiments of the present invention, individual data chunks that comprise a complete data frame (322) (i.e. the sum of their data lengths equals the data length of a complete data frame) may be grouped together (325) with a static length equal to the length of a complete data frame and stored in a static memory buffer (330).

According to some embodiments of the present invention, a functionally associated decoder circuit (340) may read demodulated data frames (332) from the static memory buffer (330), deinterleave the data bytes and decode the data with error correction, and store the decoded data frames (334) in a section of the static memory buffer (330). According to further embodiments of the present invention, the decoder circuit may concurrently perform the reading, processing and storing on three consecutive data frames.

According to some embodiments of the present invention, a functionally associated output interface (350) may read the decoded data frames (334) from the static memory buffer (330) and make it available to external data sink circuits and/or applications.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A receiver comprising:
a receive chain adapted to receive and demodulate a data frame bearing signal received at one or more carrier frequencies, said receiver further adapted to store demodulated data in a shared buffer;
a decoder circuit adapted to read received data from the shared buffer, process the received data and write the decoded data back to the shared buffer; and
an output interface adapted to read the processed data and to provide read data to one or more external data sink circuits or applications.

2. The receiver according to claim 1, wherein said decoder circuit is further adapted to reconstruct data frames from the received data.

3. The receiver according to claim 2, wherein said decoder circuit is further adapted to concurrently reconstruct two or more the data frames.

4. The receiver according to claim 1, wherein said decoder circuit is further adapted to include a byte deinterleaver and an error correcting decoder.

5. The receiver according to claims 4, wherein said decoder is adapted to read a complete data frame for deinterleaving and decoding.

6. The receiver according to claim 4, wherein said decoder circuit is further adapted to read a complete burst of the data frame bearing signal for deinterleaving and decoding.

7. The receiver according to claim 1, further adapted to power cycle said receive chain when the data frame bearing signal is received in bursts.

8. The receiver according to claim 7, further adapted to power down said receive chain in between the bursts of signal reception.

9. The receiver according to claim 1, further adapted to power cycle said decoder circuit when the data frame bearing signal is received in bursts.

10. The receiver according to claim 9, further adapted to power down said decoder circuit during the bursts of signal reception.

11. The receiver according to claim 1, wherein said shared buffer is further adapted to contain a plurality of independently accessible segments.

12. The receiver according to claim 11, wherein the segments of said shared buffer are further adapted to be accessible to one circuit or application at each clock interval.

13. The receiver according to claim 11, wherein said shared buffer includes at least one dynamically allocated memory segment and at least one statically allocated memory segment.

14. The receiver according to claim 13, wherein said shared buffer is further adapted to fill chunks of the dynamically allocated memory with fragments of the demodulated data.

15. The receiver according to claim 14, wherein said shared buffer is further adapted to move a plurality of the chunks to the statically allocated memory.

16. The receiver according to claim 15, wherein the plurality of chunks comprises a complete data frame.
